(19) United States
(12) Patent Application Publication
(10) Pub. No.: US 2026/0145458 A1
(43) Pub. Date: May 28, 2026

(54) STENCIL GRIP MAT WITH REUSABLE ADHESIVE STRIP

(71) Applicant: Effie Cho, Maspeth, NY (US)

(72) Inventor: Effie Cho, Maspeth, NY (US)

(21) Appl. No.: 18/956,516

(22) Filed: Nov. 22, 2024

(51) Int. Cl. B43L 13/20

(52) U.S. Cl. CPC B43L 13/201

(57) ABSTRACT

The present disclosure relates to a stencil grip mat 100 comprising a grip mat 102. The grip mat 102 has a front surface 110, a back surface 112, a top part 114, and a bottom part 116. The stencil grip mat 100 also comprising a cardstock 104 placed over the grip mat 102. The stencil grip mat 100 also comprising a stencil 106 placed on cardstock 104. The stencil grip mat 100 also comprising at least two strips 108 attached on the top part 114, and the bottom part 116 of the grip mat 102. The strips 108 having adhesive placed on one of the edges. The strips 108 are configured to adhere the stencil 106 to the cardstock 104 and the grip mat 102.

### FIELD OF DISCLOSURE

Embodiments of the present invention relate to a stencil grip mat and specifically relates to a stencil grip mat with reusable adhesive strip.

### BACKGROUND OF THE DISCLOSURE

Crafting is an art that demands precision, creativity, and patience. Among the various techniques used in crafting, ink blending with stencils stands out for its ability to produce intricate and vibrant designs on cardstock. However, achieving these results requires that the stencil remains perfectly stationary during the process. Traditionally, crafters used tape to secure their stencils to the cardstock. While effective, this method has several drawbacks.

Tape can leave residue on the stencil and cardstock, which can be difficult to remove and can ruin the clean appearance of the finished piece. Additionally, tape can sometimes tear the cardstock when removed, causing frustration and wasted materials. The repetitive need to apply and remove tape also disrupts the creative flow, making the crafting process less enjoyable. This challenge has led to the widespread use of grip mats, which help crafters hold their stencils in place without the need for tape.

The grip mats have offered a reusable, non-slip surface that temporarily adheres to both the stencil and the cardstock. This innovation significantly reduced the need for tape, allowing crafters to focus more on the creative process rather than on securing their materials. However, the effectiveness of grip mats hinges on the size and positioning of the stencil relative to the cardstock. For the grip mat to hold the stencil securely, a sufficient surface area of the stencil must be in contact with the mat. This works well when the stencil is larger than the cardstock, covering ample surface area. Thus, major limitation of the grip mats arises when the stencil size does not align perfectly with the cardstock.

When using a stencil smaller than the cardstock, only a portion of the stencil touches the grip mat, which is often insufficient to keep it from shifting. Even if the stencil is larger but does not make enough contact with the grip mat, the same problem occurs. This necessitates the reintroduction of tape or other adhesives to secure the stencil, negating the primary advantage of the grip mat. This limitation can lead to frustration and hinder the crafting experience, especially when precision is key.

Thus, there is a need of a mechanism that can make stencils secure and stationary on the grip mat during the ink blending.

Therefore, the present invention provides a stencil grip mat with reusable adhesive strip.

### SUMMARY OF THE DISCLOSURE

Embodiments of the present invention relate to a stencil grip mat. The stencil grip mat comprising a grip mat. The grip mat having a front surface, a back surface, a top part, and a bottom part. The stencil grip mat also comprising a cardstock placed over the grip mat. The stencil grip mat also comprising a stencil placed on cardstock. The stencil grip mat also comprising at least two strips attached on the top part, and the bottom part of the grip mat. The strips having adhesive placed on one of the edges. The strips are configured to adhere the stencil to the cardstock and the grip mat.

In accordance with an embodiment of the present invention, the strips are reusable.

In accordance with an embodiment of the present invention, the strips are made up of non-porous material.

In accordance with an embodiment of the present invention, the strips have at least one adhesive edge and a non-adhesive edge.

In accordance with an embodiment of the present invention, the adhesive edge is configured to temporarily secure the stencil to the grip mat.

In accordance with an embodiment of the present invention, the grip mat is made up of photopolymer material, such as mylar.

In accordance with an embodiment of the present invention, the stencil is made up of photopolymer material.

In accordance with an embodiment of the present invention, the stencil is either smaller or equal in dimension to the cardstock.

In accordance with an embodiment of the present invention, the grip mat is made up of anti-slip and durable material.

Another embodiment of the present invention relates to a method for securing a stencil grip mat while crafting. The method includes placing a cardstock over the grip mat. The method also includes placing a stencil on the cardstock. The method also includes attaching a plurality of strips on the grip mat from a non-adhesive edge. The method also includes sticking an adhesive edge of the strips on the stencil and securing the stencil to the grip mat.

### BRIEF DESCRIPTION OF THE DRAWINGS

So that the manner in which the above-recited features of the present invention is understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

The invention herein will be better understood from the following description with reference to the drawings, in which:

FIG. 1A illustrates a block diagram for a stencil grip mat, in accordance with an embodiment of the present invention;

FIG. 1B illustrates an exemplary strip, in accordance with an embodiment of the present invention;

FIG. 1C illustrates another exemplary strip, in accordance with an embodiment of the present invention;

FIG. 1D illustrates an exemplary stencil grip mat, in accordance with an embodiment of the present invention; and

FIG. 2 illustrates a flowchart for a method for securing a stencil grip mat while crafting, in accordance with an embodiment of the present invention.

It should be noted that the accompanying figure is intended to present illustrations of exemplary embodiments of the present disclosure. This figure is not intended to limit the scope of the present disclosure. It should also be noted that the accompanying figure is not necessarily drawn to scale.

### DETAILED DESCRIPTION OF THE DISCLOSURE

The following is a detailed description of embodiments of the disclosure depicted in the accompanying drawings. The embodiments are in such detail as to communicate the disclosure. However, the amount of detail offered is not intended to limit the anticipated variations of embodiments; on the contrary, the intention is to cover all modifications, equivalents, and alternatives falling within the spirit and scope of the present disclosure.

In the following description, numerous specific details are set forth in order to provide a thorough understanding of the embodiments of the present disclosure. It may be apparent to one skilled in the art that embodiments of the present disclosure may be practiced without some of these specific details.

Various terms as used herein are shown below. To the extent a term is used, it should be given the broadest definition persons in the pertinent art have given that term as reflected in printed publications and issued patents at the time of filing.

The terms “a” and “an” herein do not denote a limitation of quantity, but rather denote the presence of at least one of the referenced items.

The terms “having”, “comprising”, “including”, and variations thereof signify the presence of a component.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

The terms “determining”, “measuring”, “evaluating”, “assessing,” “assaying,” and “analyzing” can be used interchangeably herein to refer to any form of measurement, and include determining if an element is present or not. (e.g., detection). These terms can include both quantitative and/or qualitative determinations. Assessing may be relative or absolute.

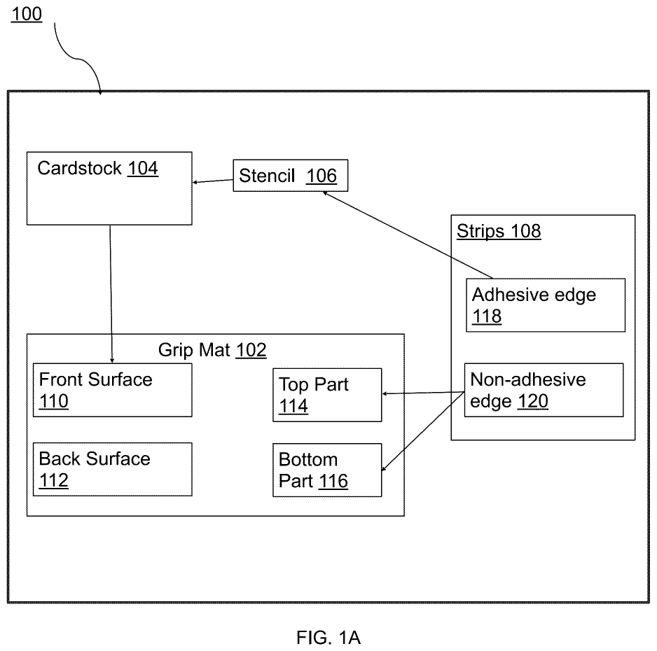

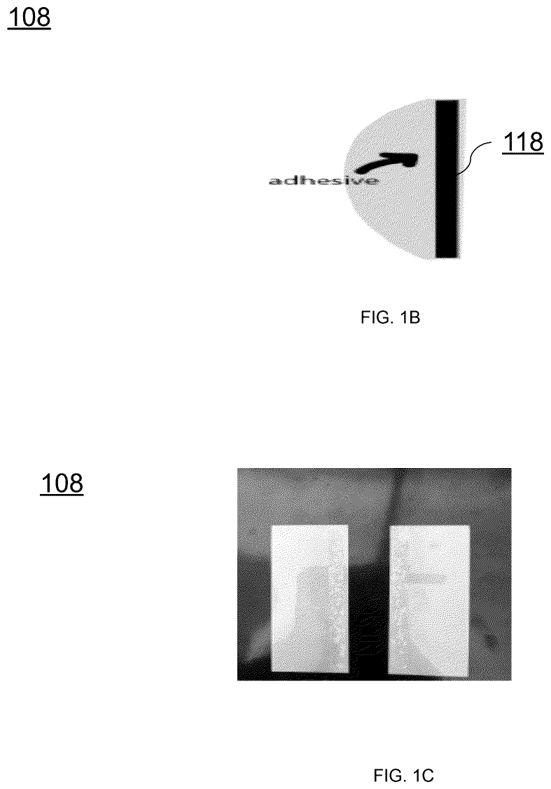

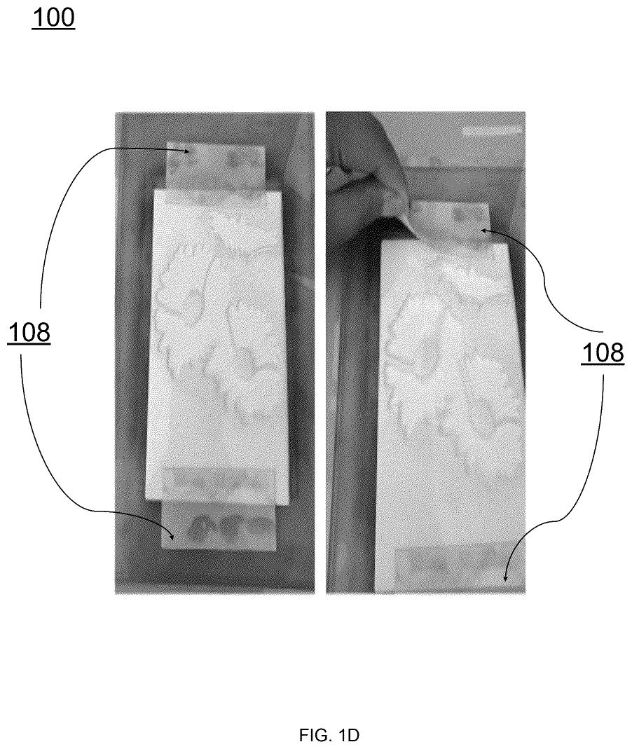

FIG. 1A illustrates a block diagram for a stencil grip mat 100, in accordance with an embodiment of the present invention.

The stencil grip mat 100 may be comprising a grip mat 102, a cardstock 104, a stencil 106, and at least two strips 108.

The grip mat 102 may have a front surface 110, a back surface 112, a top part 114, and a bottom part 116.

The grip mat 102 may be made up of anti-slip and durable material.

The cardstock 104 may be placed over the grip mat 102.

The cardstock 104 may be made up of card stock paper

The stencil 106 may be placed on cardstock 104.

The stencil 106 may be made up of photopolymer material.

The stencil 106 may be either smaller or equal in dimension to the cardstock 104.

In an embodiment of the present disclosure, the grip mat 102 may be made from any material including, but not limited to, thermoplastic elastomer (TPE). The grip mat 102 may provide a stable surface that temporarily adheres to the stencil 106, the cardstock 104, and other crafting elements, preventing any unwanted movement.

In an embodiment of the present disclosure, the cardstock 104 may be a versatile and essential material in the crafting world, prized for its durability, weight, and smooth surface. Embodiments of the present disclosure intends to cover or otherwise include any type of cardstock 104. In an embodiment of the present disclosure, the stencil 106 may be any type of stencil used in crafting.

The two strips 108 attached on the top part 114, and the bottom part 116 of the grip mat 102. The strips 108 having adhesive placed on one of the edges. The strips 108 are configured to adhere the stencil 106 to the cardstock 104 and the grip mat 102.

The strips 108 may be reusable.

The strips 108 may be made up of non-porous material.

The strips 108 may have at least one adhesive edge 118 and a non-adhesive edge 120.

The adhesive edge 118 may be configured to temporarily secure the stencil 106 to the cardstock 104.

FIG. 1B illustrates an exemplary strip 108, in accordance with an embodiment of the present invention.

FIG. 1C illustrates another exemplary strip 108, in accordance with an embodiment of the present invention.

In a preferred embodiment, the strips 108 may have a semi-circular edge as a non-adhesive edge 120. In a preferred embodiment, the strips 108 may have a linear edge as an adhesive edge 118. In some embodiments, the strips 108 may be rectangular in shape having one of its edges as an adhesive edge 118. In an embodiment of the present disclosure, the non-adhesive edge 120 is permanently attached to the grip mat using any mechanism including but not limited to, permanent adhesive.

FIG. 1D illustrates an exemplary stencil grip mat 100, in accordance with an embodiment of the present invention.

In an embodiment of the present disclosure, the adhesive used for the adhesive edge 118 may be, but not limited to, silicone adhesives that is durable and maintains its stickiness over multiple uses, acrylic adhesives that offer good durability and can be made to adhere lightly or strongly depending on the formulation, polyurethane gel adhesives that is extremely durable, do not leave residue and are highly effective for reusable applications, thermoplastic elastomer (TPE) that is easily cleaned and retains its adhesive properties over many uses. It is also resistant to wear and environmental factors.

In some embodiments, the strips 108 may be strategically placed around the stencil 108, ensuring that it remains stationary regardless of its size relative to the cardstock 102. In an embodiment of the present disclosure, the strips 108 the adhesive may be applied on one of the edges of the non-porous material piece. The strips 108 may be designed to provide the right amount of tackiness to hold the stencil 106 securely without damaging the cardstock 104. In some embodiment, the strip 108 may be easily cleaned to remove any accumulated dust or ink residue and restore the adhesive properties.

In an embodiment of the present disclosure, the non-porous material for the strip 108 may be, but not limited to, silicone rubber providing excellent flexibility and durability that makes it ideal for repeated use, polyvinyl chloride (PVC) that is cost-effective and easily available, polypropylene (PP) that is lightweight, durable, and cost-effective, thermoplastic polyurethane (TPU) that is highly flexible and durable, acrylic that offers good rigidity and strength.

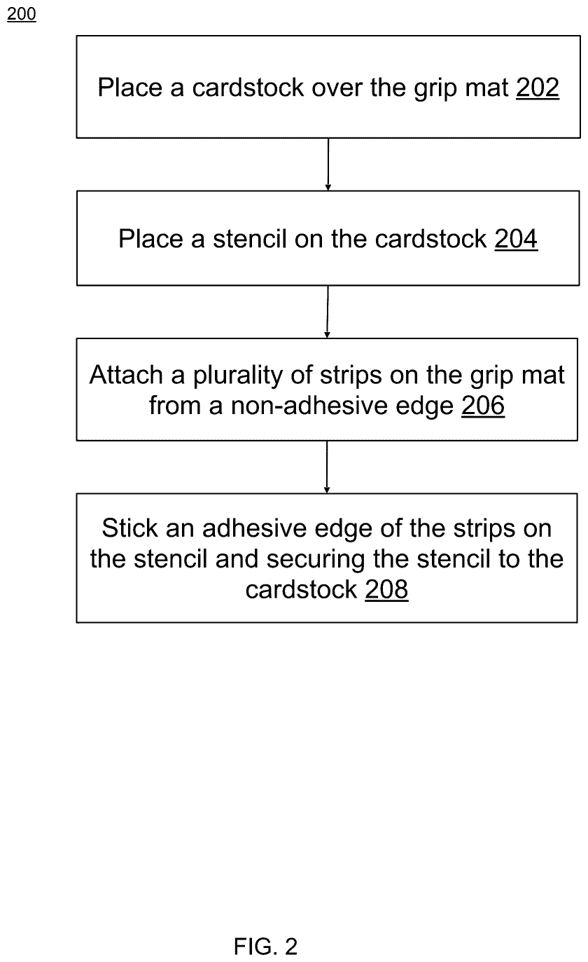

FIG. 2 illustrates a flowchart for a method 200 for securing a stencil grip mat while crafting, in accordance with an embodiment of the present invention. The method 200 may comprise the following steps.

At 202, placing a cardstock 104 over the grip mat 102.

At 204, placing a stencil 106 on the cardstock 104.

At 204, attaching a plurality of strips 108 on the grip mat 102 from a non-adhesive edge 120.

At 206, sticking an adhesive edge 118 of the strips 108 on the stencil 106 and securing the stencil 106 to the cardstock 104.

In an exemplary operational flow, the grip mat 102 may be placed on a flat, stable surface, with the cardstock 104 positioned on top. The stencil 104 may then be aligned over the cardstock 104 in the desired position. The strips 108 may be placed on either side or top or bottom of the stencil 106, with the strips 108 making contact with the stencil 106 from the adhesive edge 118. By pressing down on the adhesive edge 118, the stencil 106 may be secured in place. The method 200 may allow for smooth and precise ink blending, ensuring that the stencil 106 remains stationary throughout the project. After the project may be completed, the strips 108 may be easily removed and cleaned for future use.

In summary, the disclosed invention presents a game-changing solution and the benefits of the disclose invention are manifold. The use of two strips 108 made up of non-porous material with adhesive edge 118 may work in tandem with the grip mat 102 by extending the adhesive capability by securing the stencil 106. Thus, the disclosed invention may enhance stability during the ink blending process. The strips 108 with the adhesive edge 118 may ensure that the stencil does not shift, allowing for precise and clean ink application. This is particularly beneficial when working with detailed or intricate stencil designs where even a slight movement can ruin the pattern.

Further, the disclosed invention may eliminate the need for traditional adhesives like tape, which can damage the cardstock or leave unsightly residue. The proposed strips 108 are reusable and are designed to be gentle on materials, ensuring that both the stencil 106 and cardstock 104 remain in pristine condition. Thus, the proposed invention not only preserves the quality of the crafting materials but also enhances the overall crafting experience by reducing the cleanup time.

Moreover, the versatility of the proposed invention is a significant advantage. The strips 108 may be used with any stencil 106 and cardstock 104 combination, making them an invaluable tool for crafters who work with a varying art sizes and designs. Irrespective of the dimension of the stencil 106, i.e., whether the stencil 104 is larger, smaller, or the same size as the cardstock 104, the strip 108 may ensure that it remains securely in place on the grip mat 102, thus broadening the scope of projects that crafters can undertake with confidence.

Durability and reusability of the strips 108 are also key benefits. The non-porous material and adhesive edge 118 are designed for repeated use, making them a cost-effective addition to any crafter's toolkit. After use, the strips 108 can be cleaned, maintaining their effectiveness for future projects. This durability reduces the need for continuous replacement of adhesive materials, offering both economic and environmental benefits.

Therefore, the present invention may provide stability in keeping both the stencil 106 and cardstock 104 firmly in place, ensuring precise and clean ink application. The present invention may also eliminate the need for additional adhesive sprays or tapes that can be messy or leave residue on the art projects. The present invention may also introduce versatility to use various types of paper and the stencils 106. The present invention may also ensure that both the grip mat 102 and the strips 108 may be used for long term, be cost-effective, and provide improved craft results.

In addition to this, the disclosed invention may significantly improve workflow for crafters by eliminating the need to repeatedly apply and remove tape. With use of disclosed invention crafters may maintain their creative flow, focusing more on their artistry and less on the logistics of securing their materials. This streamlined process not only enhances efficiency but also allows the crafter to remain focused on the craft.

In a case that no conflict occurs, the embodiments in the present disclosure and the features in the embodiments may be mutually combined. The foregoing descriptions are merely specific implementations of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

I/We claim:

1. A stencil grip mat comprising:
a grip mat,
wherein the grip mat has a front surface, a back surface, a top part, and a bottom part;
a cardstock placed over the grip mat;
a stencil placed on cardstock; and
at least two strips attached on the top part, and the bottom part of the grip mat,
wherein the strips having adhesive placed on one of the edges,
wherein the strips are configured to adhere the stencil to the cardstock and the grip mat.

2. The stencil grip mat of claim 1, wherein the strips are reusable.

3. The stencil grip mat of claim 2, wherein the strips are made up of non-porous material.

4. The stencil grip mat of claim 1, wherein the strips have at least one adhesive edge and a non-adhesive edge.

5. The stencil grip mat of claim 4, wherein the strips have the adhesive edge is configured to temporarily secure the stencil to the cardstock.

6. The stencil grip mat of claim 1, wherein the cardstock is made up of photopolymer material.

7. The stencil grip mat of claim 1, wherein the stencil is made up of photopolymer material.

8. The stencil grip mat of claim 1, wherein the stencil is either smaller or equal in dimension to the cardstock.

9. The stencil grip mat of claim 1, wherein the grip mat is made up of anti-slip and durable material.

10. A method for securing a stencil grip mat while crafting, the method comprising:
placing a cardstock over the grip mat;
placing a stencil on the cardstock;
attaching a plurality of strips on the grip mat from a non-adhesive edge; and
sticking an adhesive edge of the strips on the stencil and securing the stencil to the cardstock.
